(19) United States
(12) Patent Application Publication
(10) Pub. No.: US 2023/0044450 A1
(43) Pub. Date: Feb. 9, 2023

(54) SAUCE DISPENSER MODULE AND AUTOMATIC HAMBURGER PRODUCTION SYSTEM INCLUDING THE SAME

(71) Applicant: ANIAI, INC, Seoul (KR)

(72) Inventors: Joochul CHANG, Seoul (KR); Suin KIM, Seoul (KR); Gunpil HWANG, Seoul (KR)

(21) Appl. No.: 17/546,658

(22) Filed: Dec. 9, 2021

(30) Foreign Application Priority Data
Aug. 5, 2021 (KR) 10-2021-0103153
Oct. 1, 2021 (KR) 10-2021-0130510

(51) Int. Cl. A21C 9/04; B65D 75/00; B65D 85/72; F04B 43/12

(52) U.S. Cl. CPC A21C 9/04; B65D 75/00; B65D 85/72; F04B 43/12

(57) ABSTRACT

Provided is a sauce dispenser module used in an automatic hamburger production system. The sauce dispenser module includes a sauce storage unit for storing a sauce to be dispensed, a sauce transfer unit configured to transfer the sauce of the sauce storage unit, a nozzle unit configured to dispense the sauce transferred by the sauce transfer unit in various forms, a sensor configured to monitor a state of the sauce dispensed by the nozzle unit, and a control unit configured to control the sauce transfer unit according to monitoring with a signal of the sensor.

### CROSS-REFERENCE TO RELATED APPLICATION

This application is based on and claims priority under 35 U.S.C. §119 to Korean Patent Application No. 10-2021-0103153, filed on Aug. 5, 2021, and Korean Patent Application No. 10-2021-0130510, filed on Oct. 1, 2021, in the Korean Intellectual Property Office, the disclosures of which are incorporated by reference herein in their entireties.

### BACKGROUND

### 1. Field

The present disclosure relates to a sauce dispenser module and an automatic hamburger production system including the same, and more particularly, to a sauce dispenser module for supplying a sauce used for hamburger production, and an automatic hamburger production system including the same.

### 2. Description of the Related Art

The decrease in labor force due to the rise in labor costs, population aging, low birth rates, etc., and avoidance of simple and repetitive work are driving automation for unmanned operation in many industrial fields. Also in the restaurant industry, efforts are being made to solve these issues through automated unmanned apparatuses and systems. The hamburger market has the largest number of restaurants that serve a single dish in the restaurant industry.

Japanese Patent No. 3557591 discloses a hamburger preparing apparatus which is operable in a relatively small kitchen and capable of preparing various types of hamburgers and improving productivity.

### SUMMARY

The present disclosure is to provide a hamburger automatic production system in which hamburger production that was performed by a human is automated. The present disclosure is also to provide a sauce dispenser module used in the automatic hamburger production system.

Additional aspects will be set forth in part in the description which follows and, in part, will be apparent from the description, or may be learned by practice of the presented embodiments of the present disclosure.

According to an embodiment of the present disclosure, a sauce dispenser module includes a sauce storage unit for storing a sauce to be dispensed, a sauce transfer unit configured to transfer the sauce of the sauce storage unit, a nozzle unit configured to dispense the sauce transferred by the sauce transfer unit in various forms, a sensor configured to monitor a state of the sauce dispensed by the nozzle unit, a storage state of the sauce storage unit, and a transfer state of the sauce transfer unit; and a control unit configured to control the sauce transfer unit according to a signal of the sensor.

The sauce storage unit may include at least one of a refrigerating storage unit configured to implement refrigerating storage and a heating storage unit configured to implement heating storage.

The sauce transfer unit may include a pipe body connected from the sauce storage unit to the nozzle unit to transfer the sauce in a non-contact manner, and a peristaltic pump configured to push the sauce using peristaltic movement through the pipe body embedded therein.

The nozzle unit may include a housing having a plurality of outlets, a plate coupled to the housing to define a channel between the plate and the housing, and an inlet connector formed on the plate to be connected to the channel and connected to the sauce transfer unit.

In a state that the housing is coupled to the plate, the channel may be formed in plurality to reach the inlet connector and each of the plurality of outlets.

The sensor may include at least one of a laser sensor, a proximity sensor, an ultrasonic sensor, a camera, a motor encoder sensor, and a weight sensor to detect an object at an dispensing point of the nozzle unit and monitor data related to sauce dispensing in real time.

The sauce storage unit may be formed as a pouch, and may include a female connector coupled to an opening of the pouch, and a male connector coupled to the pipe body of the sauce transfer unit, and the female connector and the male connector may be coupled to each other.

The sauce storage unit may be formed as a container, and may include a cover formed to have an area equal to an area of a bottom surface of the container and descend according to a level of a sauce inside the container.

According to an embodiment of the present disclosure, an automatic hamburger production system may include an interface unit configured to perform at least one of checking an operation of the system, controlling the system, ordering production, and managing a schedule, an automatic production management module configured to check and manage a plurality of modules constituting the system, the plurality of cooking modules configured to transmit data to the automatic production management module, a packaging module configured to supply a package and receive and package a hamburger assembled and finished on the package in the cooking modules, and an assembler module controlled by the automatic production management module to allow the package and the hamburger, which is being produced, to be transferred between the cooking modules and the packaging module while ingredients are assembled into the hamburger.

The automatic production management module may include a scheduler unit configured to control an operation order of the modules according to a production process determined by each scheduling algorithm, a data management unit configured to process and manage output signals of the respective modules and transmit the processed output signals to the scheduler unit, and a communication unit configured to connect the interface unit, the cooking modules, the packaging module, and the assembler module to each other.

The cooking modules may include a cache for storing ingredients to be used at a refrigeration, freezing, or room temperature, a local processor responsible for functions of the modules, and a sensor configured to monitor an amount of ingredients of the cache or an operation of the local processor.

The cooking modules may further include a filling dispenser module configured to supply fillings onto a hamburger being assembled in a package at a discharge unit, and the filling dispenser module may include a box containing fillings, a propeller provided inside the box to rotate to supply the fillings to an outlet, a motor for rotating the propeller, and a control unit configured to communicate with the automatic production management module to control the motor.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an automatic hamburger production system, according to an embodiment of the present disclosure;

FIG. 2 is a block diagram illustrating a basic configuration of a local module applied to FIG. 1 ;

FIG. 3 is a block diagram illustrating an automatic production management module applied to FIG. 1 ;

FIG. 4 is a perspective view illustrating a filling dispenser module applied to FIG. 1 ;

FIG. 5 is a longitudinal sectional view of FIG. 4 ;

FIG. 6 is a block diagram illustrating a sauce dispenser module applied to FIG. 1 , according to an embodiment of the present disclosure;

FIG. 7 is a perspective view illustrating the sauce dispenser module of FIG. 6 ;

FIG. 8 is a configuration diagram illustrating a peristaltic pump applied to FIGS. 6 and 7 ;

FIG. 9 is a perspective view illustrating a sauce container connected to an inlet of the peristaltic pump illustrated in FIG. 8 ;

FIG. 10 is an exploded perspective view illustrating a nozzle unit connected to an outlet of the peristaltic pump illustrated in FIG. 8 ;

FIGS. 11A and 11B are configuration diagrams illustrating states respectively before and after coupling a connector connected to a pipe body of the sauce transfer unit illustrated in FIG. 8 to a connector of a pouch; and

FIG. 12 is a block diagram illustrating a configuration for dispensing a fixed amount of a sauce through the sauce dispenser module illustrated in FIG. 6 .

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

Hereinafter, embodiments of the present disclosure will now be described in detail with reference to the accompanying drawings for one of skill in the art to be able to perform the present disclosure without any difficulty. The present disclosure may, however, be embodied in many different forms and should not be construed as being limited to the embodiments of the present disclosure set forth herein. In order to clearly describe the present disclosure, portions that are not relevant to the description of the present disclosure are omitted, and similar reference numerals are assigned to similar elements throughout the present specification.

It should be understood that when an element is referred to as being "connected to" or "coupled to" another element, the element may be directly connected or coupled to the other element or may be connected or coupled to the other element with an intervening element therebetween. It should also be understood that, on the other hand, when an element is "directly connected" or "directly coupled" to another element, there is no intervening element therebetween.

It should be understood that the terms "comprises" and/or "has" used herein specify the presence of stated features, numbers, operations, elements, components, and/or combinations thereof, but do not preclude the presence or addition of one or more other features, numbers, operations, elements, components, and/or combinations thereof. Therefore, when an element is referred to as "including" a component, the element may additionally include other components rather than excluding other components as long as there is no particular opposing recitation.

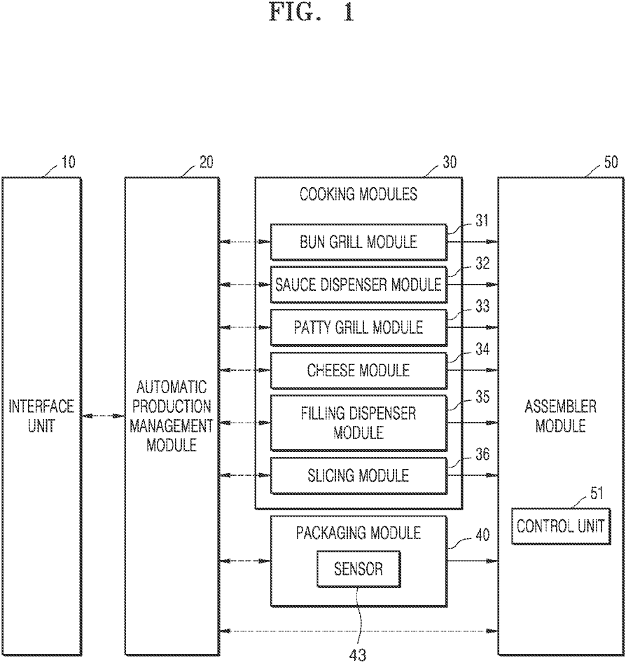

FIG. 1 is a block diagram illustrating an automatic hamburger production system, according to an embodiment of the present disclosure. Referring to FIG. 1 , the automatic hamburger production system of an embodiment includes an interface unit 10, an automatic production management module 20, a plurality of cooking modules 30, a packaging module 40, and an assembler module 50.

The interface unit 10 performs at least one of checking an operation of the system, controlling the system, ordering production, and managing a schedule. The automatic production management module 20 checks and manages a plurality of modules constituting the system. The cooking modules 30 transmits data to the automatic production management module 20.

The packaging module 40 supplies a package and receives and packages a finished hamburger having been assembled on the package in the cooking modules 30. The assembler module 50 is controlled by the automatic production management module to move the package and the hamburger being prepared, between the cooking modules 20 and the packaging module 40.

For example, the plurality of cooking modules 30 include a bun grill module 31, a sauce dispenser module 32, a patty grill module 33, a cheese module 34, a filling dispenser module 35, and a slicing module 36.

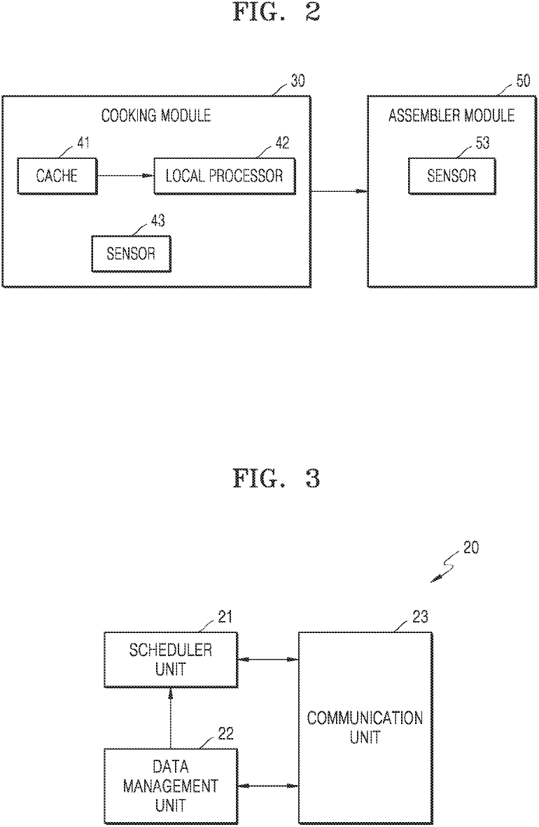

FIG. 2 is a block diagram illustrating a basic configuration of a local module applied to FIG. 1 . Referring to FIG. 2 , the plurality of cooking modules 30 includes a cache 41 for storing, at a refrigeration, freezing, or room temperature, an amount of ingredients for temporary use, and a local processor 42 responsible for functions of individual modules, and a sensor 43 for monitoring the capacity of the cache 41 or whether the local processor 42 is normally operating.

In addition, the packaging module 40 and the assembler module 50 include sensors 43 and 53 for monitoring whether they are normally operating. The sensors 43 and 53 are attached to the cooking modules 30, the packaging module 40, and the assembler module 50, to monitor the capacity of the cache 41 or whether the local processor 42 is normally operating, and may also be attached to the system to perform real-time monitoring of operations performed by the respective modules or between the modules, and real-time monitoring of error situations.

Sensor data collected by the sensors 43 and 53 may be transmitted to the automatic production management module 20 in real time to perform corrective actions through feedback, or may be accumulated to be used for big data-based artificial intelligence learning. In this case, signals includes at least one of video, digital image, infrared, weight, and temperature signals, and the sensors 43 and 53 include at least one of a camera sensor, an audio sensor, an ultrasonic sensor, an infrared sensor, a gravity sensor, a weight sensor, and a temperature sensor.

In a flowchart of ingredients when the plurality of cooking modules 30 are operating, the ingredients stored in the cache 41 are transferred to the local processor 42 through a cache-to-local processor movement, then a cooking operation is performed by the local processor 42, the resulting products are transferred to the assembler module 50 through a local processor-to-assembler module movement to be assembled, and then the assembled product is moved to the next module.

The automatic hamburger production system of FIG. 1 is an example of a configuration that operates as a fully automatic production system using all of the modules. Although not illustrated, the automatic hamburger production system may operate as a partially automatic production system by selectively combining one or more modules according to needs of a user.

For convenience of description, the automatic hamburger production system will be described as a fully automatic production system. First, the interface unit 10, the automatic production management module 20, the plurality of cooking modules 30, the packaging module 40, and the assembler module 50 will be described in detail.

The interface unit 10 is an interface through which the user may check and control the operation of the system, and performs operations of ordering production, initiating and terminating the system, managing a schedule, and checking a system error element.

For example, the interface unit 10 is a digital device having a function of accessing and then communicating with the automatic production management module 20, and includes at least one of a smart phone, a tablet, a smart watch, a smart band, a smart glass, a desktop computer, a monitor, a notebook computer, a workstation, a personal digital assistant (PDA), a web pad, a mobile phone, and a human-machine interface (HMI). That is, a device capable of allowing the user to check a digital output and input information thereto may be adopted as the interface unit 10.

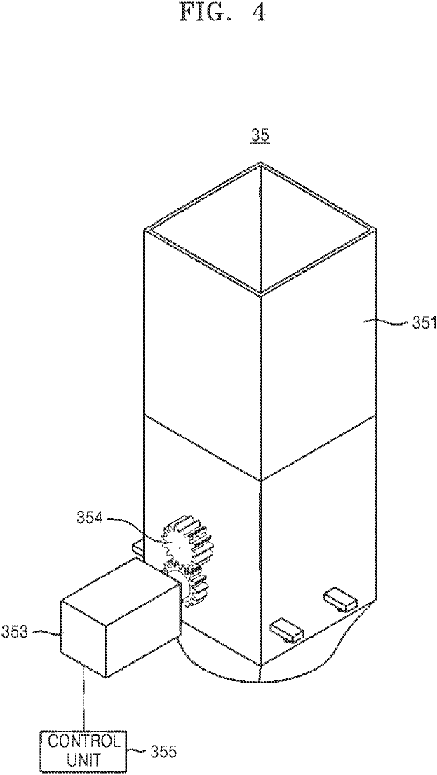

FIG. 3 is a block diagram illustrating the automatic production management module 20 applied to FIG. 1 . Referring to FIGS. 1 and 3 , the automatic production management module 20 includes a scheduler unit 21, a data management unit 22, and a communication unit 23.

The automatic production management module 20 is a digital device having a function of communicating with each module, and may include at least one of a smart phone, a tablet, a smart watch, a smart band, smart glasses, a desktop computer, a monitor, a notebook computer, a workstation, a PDA, and a programmable logic controller (PLC). That is, a digital device including a memory unit and a microprocessor mounted therein and thus having computing capability may be adopted as the automatic production management module 20.

The scheduler unit 21 checks the modules connected to the system and controls the operation order of the modules according to a production process determined by a scheduling algorithm. The scheduler unit 21 may primarily identify the number and states of modules connected to the system. Here, the state includes whether the module is usable, whether an error occurred, whether to the module is cleaned, and the version of the module.

Based on the primarily identified states and number of the modules, the scheduler unit 21 determines a module operation order schedule for producing hamburgers according to types and numbers of hamburger orders input from the interface unit 10, and controls each module through the communication unit 23. Here, the module operation order schedule is determined according to a preset scheduling algorithm.

The scheduler unit 21 may maximally maintain the freshness in cooking by using a reverse scheduling algorithm that estimates a previous module cooking start time inversely calculated from a next module cooking completion time such that a period of time during which the ingredients having been cooked in each module stand by for the ingredient to be completely cooked in the next module is minimized.

The scheduling algorithm includes a built-in scheduling algorithm and a scheduling algorithm which is determined by the user. An example of the built-in scheduling algorithm may be an algorithm that maximizes the per-hour production of hamburgers. In this case, the built-in scheduling algorithm may be updated from a central server through the communication unit 23.

The data management unit 22 signal-processes and manages outputs of the sensors 43 and 53 in each module and transmits the resulting data to the scheduler unit 21. The outputs of the sensors 43 and 53 include all signals involved in a hamburger production process, such as whether an error occurred, video, digital images, infrared signals, weight, temperature, etc. The data management unit 22 may transmit and receive collected data to and from the central server through the communication unit 23.

The data management unit 22 may perform a function of training ingredient management and module control models based on data regarding an input of the interface unit 10. An estimation model according to an embodiment may be implemented by using an artificial neural network such as a convolutional neural network (CNN) and a recurrent neural network (RNN). In addition, descriptions provided herein is merely an embodiment of the present disclosure, and a technique that may be used to implement and train the estimation model may be variously modified within the scope of achieving the object.

The communication unit 23 is configured as a communication network that connects the interface unit 10, the automatic production management module 20, the plurality of cooking modules 30, the packaging module 40, the assembler module 50, and the central server (not shown) to each other. Here, the central server is a central system installed at a location separate from the system, and may be connected through the Internet or World Wide Web (WWW).

The communication unit 23 may be configured to perform both wired communication and wireless communication, and may be configured as at least one of a controller area network (CAN), EtherCAT, TCP/IP Modbus, serial Modbus, a local area network (LAN), a metropolitan area network (MAN), and a wide area network (WAN).

For example, the communication network may be the known Internet or WWW. The communication network may also include part of a known wired/wireless data communication network, a known telephone network, or a known wired/wireless television communication network.

The plurality of cooking modules 30 will be described with reference to FIGS. 1 and 2 . The plurality of cooking modules 30 include the cache 41 and the local processor 42 corresponding to respective cooking.

First, the bun grill module 31 is configured to handle bread, and ingredients handled by the bun grill module 31 is not limited to bread, but include cooked rice in a certain shape to replace the role of a burger bun, or an ingredient for vertically wrapping fillings of a hamburger.

Buns are stored in the cache 41 in a frozen state, a refrigerated state, or a room temperature state according to the type and characteristics of the buns, and a cooking time and temperature during cooking may be adjusted by the local processor 42. The cache 41 of the bun grill module 31 may also be configured to block external air so as to prevent the surface of a bun from drying out.

The bun grill module 31 may include the sensors 43, for example, a pressure sensor or a position sensor, and a control unit 51 of the assembler module 50 may appropriately adjust a degree of bun cooking by feeding back an appropriate cooking pressure, time, position, and the like according to the type and state of a bun (e.g., the thickness and temperature of the bun) and monitor the state.

The sensors 43 of the bun grill module 31 may further include a state measurement sensor capable of determining the temperature, hardness, color, and degree of cooking of a bun, and accordingly, the cooking temperature and time of the bun can be adjusted.

The control unit 51 of the assembler module 50 includes any one of a microcontroller unit (MCU), a field-programmable gate array (FPGA), a digital signal processor (DSP), a smart phone, a tablet, a smart watch, a smart band, a smart glass, a desktop computer, a monitor, a notebook computer, a workstation, a PDA, and a PLC. A digital device having computing capability may be adopted as the control unit 51 of the assembler module 50.

The assembler module 50 is configured to transfer, to discharge units of the cooking modules 30 and the packaging module 40, ingredients to be sequentially supplied to a packaging paper sheet or box. The control unit 51 of the assembler module 50 is configured to control the packaging paper sheet or box containing food ingredients to stand by or move, and communicate with the automatic production management module 20.

The control unit 51 controls the assembler module 50 based on an input signal of the automatic production management module 20, and communicates a state of the assembler module 50 to the automatic production management module 20. Here, the state of the assembler module 50 may include whether the assembler module 50 is operable, whether the assembler module 50 is currently operating, whether an error occurred, and an operation speed.

The patty grill module 33 includes a heating module for heating beef, pork, chicken, or vegan meat, and a fryer module for frying shrimp, chicken, and potato hash brown. For example, the heating module may include a heating device for cooking a patty, and may include, as a heat source, at least one of an induction range, a heating wire, an electromagnetic wave device, and an infrared device.

The heating module may further include a seasoning module (not shown) for seasoning using salt, pepper, and herbs during cooking according to the type of a patty, and a control unit (not shown) of the fryer module may adjust a seasoning time, type, and amount.

For example, the fryer module may perform an operation of putting a patty into oil and taking the patty out of the oil, may filter out residues from the oil after frying, and may perform an oil replacement operation according to an oil acidity measurement result.

Control units applied to the heating module and the fryer module includes at least one of an MCU, an FPGA, a DSP, a smart phone, a tablet, a smart watch, a smart band, a smart glass, a desktop computer, a monitor, a notebook computer, a workstation, a PDA, and PLC. A digital device having computing capability may be adopted as the control unit.

A cache of the patty grill module 33 may be maintained in a frozen state, a refrigerated state, or a non-room temperature state according to the characteristics of a patty, and may include packaging that blocks inflow and internal circulation of external air for maintaining freshness.

The cheese module 34 supplies cheese onto a hamburger being assembled, by the assembler module 50, on a package paper sheet or box at a discharge unit of the cheese module 34. Here, the types of cheese includes at least one of sliced cheese, shredded cheese, and liquid cheese.

The cheese module 34 may supply, directly to the assembler module 50, cheese stored in a cache capable of temporarily storing the cheese at a refrigeration temperature, a freezing temperature, and a room temperature, or may heat the cheese to an appropriate temperature through a local processor such as a hot air blower or an oven and supply the heated cheese to the assembler module 50.

The filling dispenser module 35 supplies, onto the hamburger being assembled on the package paper sheet or box on the discharge unit, fixed amounts of various fillings at a preset speed according to the type of the hamburger. Here, the fillings include onions, lettuce, and pickles.

The filling dispenser module 35 may supply, directly to the assembler module 50, fillings stored in a cache capable of temporarily storing ingredients at a refrigeration temperature, a freezing temperature, and a room temperature, or may supply only the ingredients to the assembler module 50 while blocking liquid flowing out of the fillings by using a local processor such as a liquid blocker.

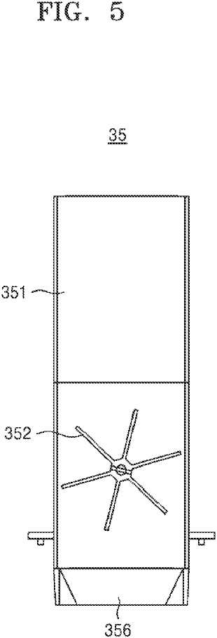

FIG. 4 is a perspective view illustrating the filling dispenser module 35 applied to FIG. 1 , and FIG. 5 is a longitudinal sectional view of FIG. 4 . Referring to FIGS. 1, 4, and 5 , the filling dispenser module 35, which is an apparatus for dispensing ingredients such as lettuce and onions based on a digital input, includes a box 351, gears 354 and a motor 353 for rotating a propeller 352 inside the box 351, and a control unit 355. The control unit 355 controls the motor 353 by communicating with the automatic production management module 20. In the filling dispenser module 35, the box 351 corresponds to the cache 41, and the propeller 352, the gears 354, and the motor 353 correspond to the local processor 42.

The box 351 is a container capable of accommodating ingredients and has the rotatable propeller 352 built therein. The box 351 and the motor 353 may be separated from each other. When the box 351 and the motor 353 are coupled to each other, the gears 354 are engaged with each other, and the motor 353 may drive the propeller 352 through the gears 354. By using this, the ingredients in the box 351 are discharged through a discharge port 356 to be supplied onto the hamburger being assembled on the package paper sheet or box at the discharge unit of the material dispenser module 35.

For example, the propeller 352 may be formed of a soft flexible material, that is, silicon or a material having similar properties, or a hard material, that is, a metal, plastic, or a material having similar properties.

The motor 353 is a device for generating a rotational motion based on a digital input, and may include at least one of a geared motor, a stepper motor, a servo motor, a brush motor, and a brushless motor.

The control unit 355 controls, based on an input signal received from the automatic production management module 20, the motor 353 to rotate clockwise or counterclockwise, and communicates the state of the filling dispenser module 35 with the automatic production management module 20. Here, the state of the filling dispenser module 35 includes whether the filling dispenser module 35 is operable, whether the filling dispenser module 35 is currently operating, and whether an error occurred.

The control unit 355 includes at least one of an MCU, a FPGA, a DSP, a smart phone, a tablet, a smart watch, a smart band, a smart glass, a desktop computer, a monitor, a notebook computer, a workstation, a PDA, and a PLC. A digital device having computing capability may be adopted as the control unit 355.

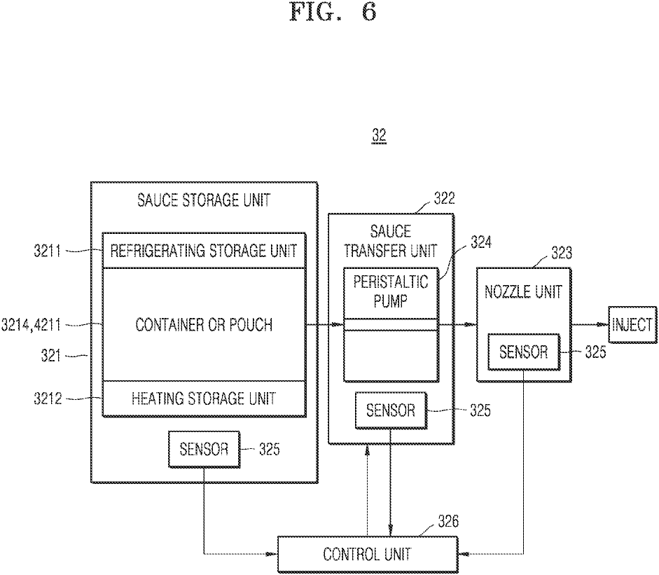

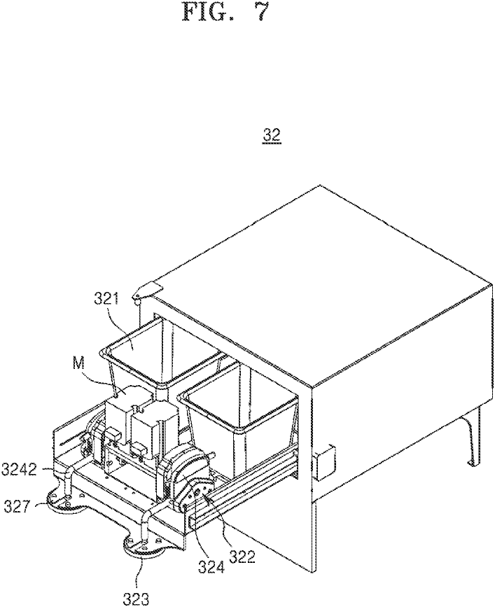

FIG. 6 is a block diagram illustrating the sauce dispenser module 32 applied to FIG. 1 , according to an embodiment of the present disclosure, and FIG. 7 is a perspective view illustrating the sauce dispenser module 32 of FIG. 6 .

Referring to FIGS. 6 to 7 , the sauce dispenser module 32, which is a device for dispensing a sauce or dressing ingredient based on a digital input, includes a sauce storage unit 321 for storing a sauce to be dispensed, a sauce transfer unit 322 for transferring the sauce of the sauce storage unit 321, a nozzle unit 323 for dispensing, in various forms, the sauce transferred by the sauce transfer unit 322, a sensor 325 provided in the nozzle unit 323 to monitor a state (e.g., an automatic dispensing position and a weight of the dispensed sauce) of the sauce being dispensed, and a control unit 326 for communicating with the automatic production management module 20 to control the sauce transfer unit 322.

The sensor 325 is also provided in each of the sauce storage unit 321 and the sauce transfer unit 322 so as to monitor a sauce storage state of the sauce storage unit 321 and a sauce transfer state of the sauce transfer unit 322. The control unit 326 may monitor data related to sauce dispensing through the sensors 325 and communicate with the automatic production management module 20 to more accurately control the sauce transfer unit 322.

In the sauce dispenser module 32, the sauce storage unit 321 corresponds to the cache 41, and the sauce transfer unit 322 and the nozzle unit 323 correspond to the local processor 42. Ingredients handled by the sauce dispenser module 32 may include a hamburger sauce, a salad dressing, ice cream syrup, fruit jam, and various edible liquids.

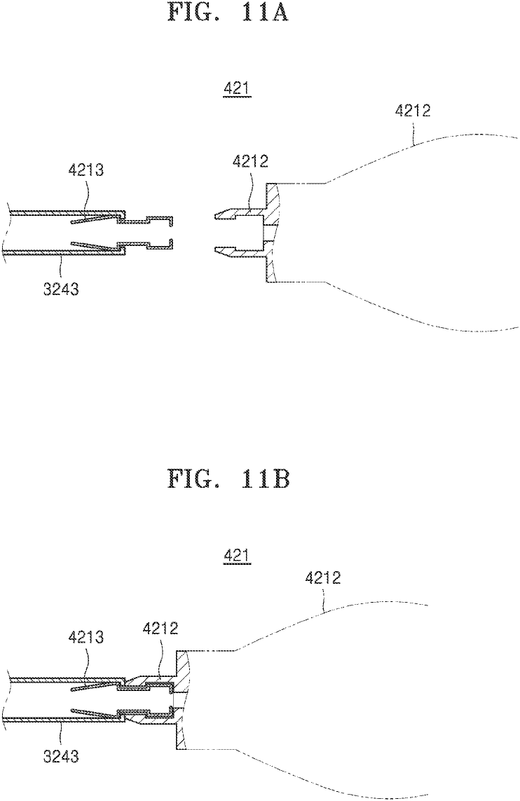

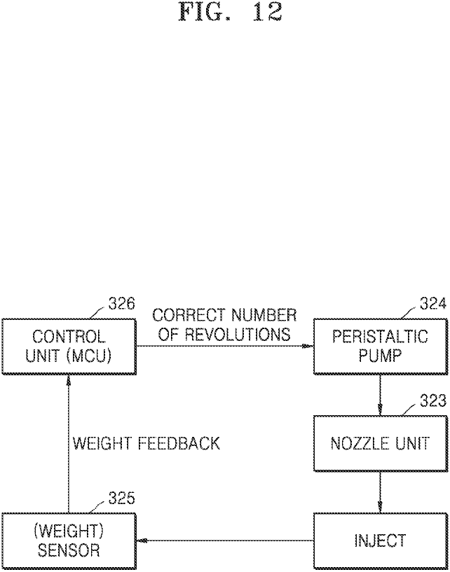

The sauce storage unit 321 is a device for storing a sauce in various forms, and may be formed as a container (see FIG. 9 ) or a pouch (see FIGS. 11 a and 11 b ). The forms in which the sauce is stored may include a dedicated sauce pouch, a dedicated metal sauce container, a commercially available sauce pouch, and a plastic sauce container.

The sauce storage unit 321 may include a refrigerating storage unit 3211 and a heating storage unit 3212 which perform sealing, heat insulation, and refrigerating or heating storage according to the storage characteristics of a sauce. Here, the refrigerating storage unit 3211 may include at least one of a thermoelectric element, a compressor using a refrigerant, and a stirling cooler, and the heating storage unit 3212 may include at least one of a thermoelectric element, a heating wire, and infrared rays.

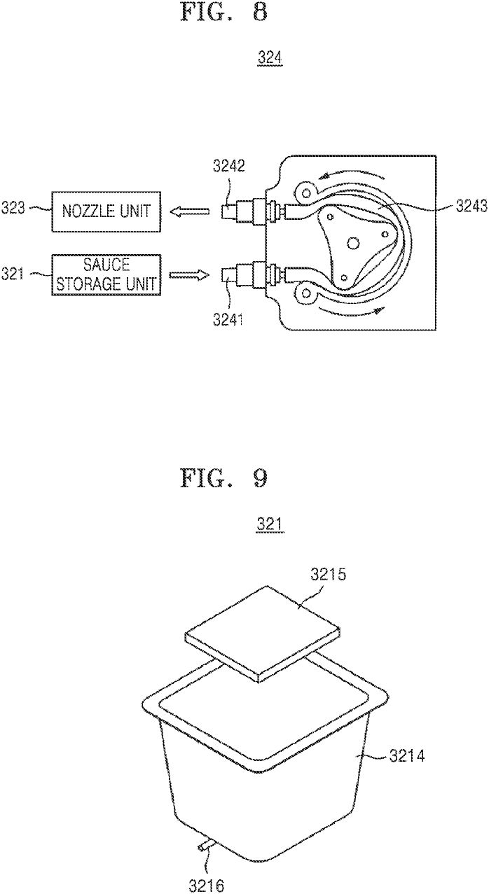

FIG. 8 is a configuration diagram illustrating a peristaltic pump 324 applied to FIGS. 6 and 7 , and FIG. 9 is a perspective view illustrating a sauce container connected to an inlet of the peristaltic pump 324 illustrated in FIG. 8 . Referring to FIGS. 6 to 9 , the sauce transfer unit 322 is configured to connect the sauce storage unit 321 to the nozzle unit 323 and to transfer the sauce through peristaltic movement.

For example, the sauce transfer unit 322 includes a pipe body 3243 that transfers the sauce in a non-contact manner, and the peristaltic pump 324 having the pipe body 3243 embedded therein. The control unit 326 communicates with the automatic production management module 20 and controls the peristaltic pump 324. The pipe body 3243 in the peristaltic pump 324 is connected to the sauce storage unit 321 through an inlet 3241, and is connected to the nozzle unit 323 through an outlet 3242.

The pipe body 3243 embedded in the peristaltic pump 324 in the sauce transfer unit 322 allows the sauce to be transferred from the sauce storage unit 321 to the nozzle unit 323 without contacting external elements such as air, a motor M, and the pump. The pipe body 3243 of the sauce transfer unit 322 may be formed of at least one of a silicone tube, a Tygon tube, a medical tube, an SUS pipe, and a plastic pipe, which have an approved food safety grade.

In the sauce transfer unit 322, the peristaltic pump 324 provides a transfer force without direct contact with the sauce in the pipe body 3243, and may be replaced with a non-contact pump such as a diaphragm pump. The peristaltic pump 324 may be driven by an electric motor, an electric linear actuator, or an electric power device. The peristaltic pump 324, for example, the electric power device, is driven according to an input signal of the control unit 326 of the sauce dispenser module 32 to transfer a required amount of the sauce of the sauce storage unit 321 to the nozzle unit 323.

Referring to FIG. 9 , the sauce storage unit 321 is formed as a container 3214, and includes a cover 3215 having the same area as that of the bottom surface of the container 3214. The cover 3215 may be configured to prevent air pockets from being formed in the center of the sauce while being lowered with the top surface of the sauce when the level of the sauce is lowered as the sauce is supplied to the peristaltic pump 324 through an outlet 3216 in the container 3214, so as to allow the entire amount of the sauce to be supplied.

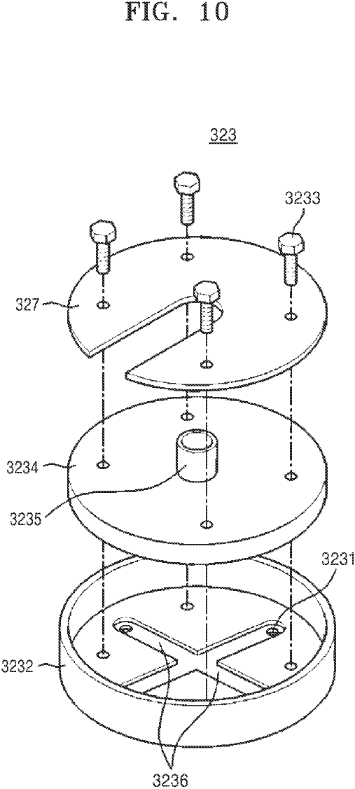

FIG. 10 is an exploded perspective view illustrating the nozzle unit 323 connected to the outlet 3242 of the peristaltic pump 324 illustrated in FIG. 8 . Referring to FIGS. 8 to 10 , the nozzle unit 323 is configured to dispense a sauce in various forms according to a purpose. For example, the nozzle unit 323 may dispense a sauce in at least one of a single-point dispensing manner, a multi-point dispensing manner, a spray-type dispensing manner, and a sprinkler-type dispensing manner.

For example, the nozzle unit 323 may include a housing 3232 forming a plurality of outlets 3231, a plate 3234 coupled to the housing 3232 by using fastening members 3233, and an inlet connector 3235 formed in the plate 3234 and connected to the outlet 3242 of the peristaltic pump 324.

In a state that the housing 3232 is coupled to the plate 3234, channels 3236 are formed between the inlet connector 3235 and the plurality of outlets 3231 to reach each of them. One side of the channel 3236 is a groove formed in the housing 3232, and the other side is an inner surface of the plate 3234.

Accordingly, the sauce dispensed into the inlet connector 3235 may be gradually transferred to the respective outlets 3231 through the respective channels 3236 to be dispensed. The sauce may be prevented from being left in the nozzle unit 323 for a long period of time.

The plurality of outlets 3231 may widely dispense the sauce onto the hamburger being assembled on the package paper sheet or box at the discharge unit of the sauce dispenser module 32. In addition, the nozzle unit 323 may be mounted on a bracket 327 of the sauce dispenser module 32 by the fastening members 3233.

The sensor 325 of the nozzle unit 323 may detect an object at an automatic dispensing point and monitor data related to the sauce dispenser module 32 in real time. The sensor 325 of the sauce storage unit 321 may monitor the sauce storage state, and the sensor 325 of the sauce transfer unit 322 may monitor the sauce transfer state. For example, the sensor 325 may include at least one of a laser sensor, a proximity sensor, an ultrasonic sensor, a camera, a motor encoder sensor, and a weight sensor.

In the sauce dispenser module 32, the control unit 326 controls the peristaltic pump 324 based on an input signal of the automatic production management module 20, and communicates data of the sensor 325 and a state of the module to the automatic production management module 20. Here, the state of the sauce dispenser module 32 may include at least one of the amount of the remaining sauce, detection of an object at the automatic dispensing position, whether the sauce dispenser module 32 is operable, whether the sauce dispenser module 32 is currently operating, and whether an error occurred.

FIGS. 11 a and 11 b are configuration diagrams illustrating states respectively before and after coupling a connector 4213 connected to the pipe body 3243 of the sauce transfer unit 322 illustrated in FIG. 8 to a connector 4212 of a pouch 4211. Referring to FIGS. 9, 11 a and 11 b , the sauce storage unit 421 is formed as the pouch 4211, and includes the female connector 4212 coupled to an opening of the pouch 4211 from which a lid has been removed, and the male connector 4213 coupled to the pipe body 3243 of the sauce transfer unit 322.

When replacing the pouch 4211, the sauce storage unit 421 may prevent the inflow of air by coupling the female connector 4212 to the male connector 4213 to connect the pouch 4211 to the pipe body 3243.

As illustrated in FIG. 9 , in the case where the sauce storage unit 321 is formed as the container 3214 and the outlet 3216 is of a pipe type, a sauce may be directly dispensed into the container 3214 to be used, and the pipe body 3243 of the peristaltic pump 324 may be directly connected to the pipe-type outlet 3216 to be used.

FIG. 12 is a block diagram illustrating a configuration for dispensing a fixed amount of a sauce through the sauce dispenser module 32 illustrated in FIG. 6 . Referring to FIG. 12 , the sauce dispenser module 32 enables dispensing of a fixed amount of the sauce regardless of surrounding environments.

For example, when the peristaltic pump 324 is driven by a stepper motor, the dispensing amount may be adjusted based on the number of revolutions of the stepper motor. Under the same condition, the peristaltic pump 324 ensures the same dispensing amount during one revolution, and may adjust the dispensing amount according to a situation of the system by using the stepper motor capable of accurately adjusting the number of revolutions.

For example, the control unit 326 configured as an MCU controls the peristaltic pump 324 by using the stepper motor. Here, the sensor 325 configured as a weight sensor applies measured weight to the control unit 32.

The control unit 326 may measure the weight of the sauce before and after being dispensed according to a signal of the sensor 325 to recognize an error between a target dispensing amount and the actual dispensing amount and control the number of revolutions of the peristaltic pump 324 to adjust the next dispensing amount.

Weight feedback by the sensor 325 allows the control unit 326 to correct the number of revolutions to enable dispensing of a fixed amount when the peristaltic pump 324 performs dispensing once with the same number of revolutions, even when the dispensing amount is changed by the type of a sauce, the ambient temperature, etc.

Meanwhile, because the control unit 326 reversely rotates the peristaltic pump 324 immediately after the sauce is dispensed through the nozzle unit 323 so as to transfer the remaining sauce backward, the amount of the remaining sauce outside the nozzle unit 323 may be minimized, and thus the amount of the sauce flowing on the floor may be minimized.

Referring back to FIGS. 1 and 2 , the slicing module 36 slices various fillings and supplies the sliced fillings to the hamburger being assembled, by the assembler module 50, on the package paper sheet or box at the discharge unit. Here, the fillings include at least one of onions, tomatoes, pickles, and cheese.

The slicing module 36 may cut fillings temporarily stored in the cache 41 capable of maintaining a refrigeration, freezing, or room temperature, into an appropriate thickness through the local processor 42 including at least one of a straight blade, a rotating blade, and a wire blade, and the cut fillings are supplied to the assembler module 50.

The packaging module 40 performs an operation of separating package paper sheets or boxes into individual pieces and accurately positioning the individual pieces in the assembler module 50. The packaging module 40 performs a packaging finishing operation such as folding or covering a finished hamburger having been assembled on a package paper sheet or box by the assembler module 50, and then discharges the packaged hamburger through the assembler module 50, or directly discharges the packaged hamburger.

The assembler module 50 is a transfer unit for allowing a hamburger to be assembled while being transferred, and the automatic production management module 20 moves the assembler module 50 to be sequentially positioned at the plurality of cooking modules 30 and the discharge unit of the packaging module 40 according to the order for each type of hamburger. The region within which the assembler module 50 moves includes the entire region of the automatic production system, and the assembler module 50 has a speed for satisfying the highest production speed and the lowest delay time.

According to a general assembly order of a hamburger, the assembler module 50 is moved to the discharge unit of the packaging module 40 to receive a package paper sheet or box on which a hamburger is assembled, is moved to a module among the cooking modules 30 according to the order for each type of hamburger, and is moved between the cooking modules 30.

Here, the assembler module 50 may include at least one of a 1-axis robot with respect to X-axis Y-axis and Z-axis, a 2-axis robot, a 3-axis robot, a 4-axis robot such as a Selective Compliance Assembly Robot Arm (SCARA) robot, a 6-axis robot such as a cooperative robot arm, and an N-axis robot, which may be obtained by additionally combining a rotational motion with such multi-axis robots, and end effectors.

As described above, the automatic hamburger production system according to an embodiment of the present disclosure enables automatic production of a hamburger, which was manually performed by a human, without human intervention. According to an embodiment, a hamburger may be produced by fully automating all processes other than filling of ingredients.

According to an embodiment, a hamburger is produced step by step by processing each ingredient in each module, and thus hamburgers with various recipes may be produced, recipe customization may be implemented, and the production may be controlled and monitored. According to an embodiment, some of the modules are partially automated, and thus, modules may be appropriately selected and combined to be used as necessary.

According to an embodiment, high product price competitiveness compared to labor costs is achieved, the production of hamburgers per unit time is improved, waiting time after ordering is minimized, and 24-hour continuous operation is enabled. According to an embodiment, production errors may be monitored in real time and a hygienically clean production environment compared to a kitchen operated by a human may be implemented.

Also, the sauce dispenser module according to an embodiment of the present disclosure is applied to the automatic hamburger production system so as to supply a sauce in a non-contact manner by using the pipe body received power of the peristaltic pump, thereby allowing the sauce to be hygienically supplied and dispensed to a hamburger being produced.

The sauce dispenser module according to an embodiment may uniformly dispense a sauce to a hamburger being produced by performing multi-dispensing with the nozzle unit, and may implement dispensing of a fixed amount by automatically correcting an error in the dispensing process.

The sauce dispenser module according to an embodiment may include a refrigerating storage unit or a heating storage unit to satisfy a storage temperature of a sauce during a period of time required before being supplied and dispensed.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A sauce dispenser module comprising:
a sauce storage unit for storing a sauce to be dispensed;
a sauce transfer unit configured to transfer the sauce of the sauce storage unit;
a nozzle unit configured to dispense the sauce transferred by the sauce transfer unit in various forms;
a sensor configured to monitor a state of the sauce dispensed by the nozzle unit, a storage state of the sauce storage unit, and a transfer state of the sauce transfer unit; and
a control unit configured to control the sauce transfer unit according to a signal of the sensor.

2. The sauce dispenser module of claim 1, wherein the sauce storage unit comprises at least one of a refrigerating storage unit configured to implement refrigerating storage and a heating storage unit configured to implement heating storage.

3. The sauce dispenser module of claim 1, wherein the sauce transfer unit comprises
a pipe body connected from the sauce storage unit to the nozzle unit to transfer the sauce in a non-contact manner, and
a peristaltic pump configured to push the sauce using peristaltic movement through the pipe body embedded therein.

4. The sauce dispenser module of claim 1, wherein the nozzle unit comprises
a housing having a plurality of outlets,
a plate coupled to the housing to define a channel between the plate and the housing, and
an inlet connector formed on the plate to be connected to the channel and connected to the sauce transfer unit.

5. The sauce dispenser module of claim 4, wherein the channel is formed in plurality to reach the inlet connector and each of the plurality of outlets in a state that the housing is coupled to the plate.

6. The sauce dispenser module of claim 1, wherein the sensor comprises at least one of a laser sensor, a proximity sensor, an ultrasonic sensor, a camera, a motor encoder sensor, and a weight sensor to detect an object at an dispensing point of the nozzle unit and monitor data related to sauce dispensing in real time.

7. The sauce dispenser module of claim 1, wherein
the sauce storage unit is formed as a pouch, and comprises a female connector coupled to an opening of the pouch, and a male connector coupled to the pipe body of the sauce transfer unit, and
the female connector and the male connector are coupled to each other.

8. The sauce dispenser module of claim 1, wherein the sauce storage unit is formed as a container, and comprises a cover formed to have an area equal to an area of a bottom surface of the container and descend according to a level of a sauce inside the container.
